(19) United States
(12) Patent Application Publication
(10) Pub. No.: US 2026/0170733 A1
(43) Pub. Date: Jun. 18, 2026

(54) IMAGE DISPLAY APPARATUS, IMAGE DISPLAY METHOD, PROGRAM, AND STORAGE MEDIUM

(71) Applicant: FUJIFILM Corporation, Tokyo (JP)

(72) Inventor: Kazuma TSUKAGOSHI, Saitama (JP)

(73) Assignee: FUJIFILM Corporation, Tokyo (JP)

(21) Appl. No.: 19/530,258

(22) Filed: Feb. 4, 2026

Related U.S. Application Data
(63) Continuation of application No. PCT/JP2024/028059, filed on Aug. 6, 2024.

(30) Foreign Application Priority Data
Aug. 10, 2023 (JP) 2023-131105

(51) Int. Cl. G06T 11/60; G06V 10/25

(52) U.S. Cl. CPC G06T 11/60; G06V 10/25

(57) ABSTRACT

Provided are an image display apparatus, an image display method, a program, and a storage medium capable of determining an appropriate image layout in consideration of the intention of a user to disclose an image.

An image display apparatus according to one embodiment of the present invention includes a processor, in which the processor is configured to: identify, for each of a plurality of images, a subject within the image; determine a selected subject from among the subjects identified for the plurality of respective images; set, for display of the plurality of images, a display layer for each image such that an image region of the selected subject in a first image including the selected subject is hidden by a second image different from the first image; and display each of the plurality of images, including the first image and the second image, on the set display layer.

### CROSS-REFERENCE TO RELATED APPLICATIONS

This application is a Continuation of PCT International Application No. PCT/JP2024/028059 filed on Aug. 6, 2024, which claims priority under 35 U.S.C. § 119(a) to Japanese Patent Application No. 2023-131105 filed on Aug. 10, 2023. The above applications are hereby expressly incorporated by reference, in their entirety, into the present application.

### BACKGROUND OF THE INVENTION

### 1. Field of the Invention

An embodiment of the present invention relates to an image display apparatus, an image display method, a program, and a storage medium.

### 2. Description of the Related Art

A technique of arranging and displaying an image group consisting of a plurality of images in a layout region on a display screen has already been developed, and the technique disclosed in JP2004-328711A is an example thereof.

The image list display device disclosed in JP2004-328711A includes an image database that stores a plurality of electronic images, a selection unit that selects a part or all of the plurality of images stored in the image database, a thumbnail image formation unit that changes a size of the image selected by the selection unit to form a thumbnail image, a thumbnail image disposition unit that randomly disposes the thumbnail image formed by the thumbnail image formation unit in an image list region, an output unit that outputs the image list region in which the thumbnail image is disposed by the thumbnail image disposition unit as an image list, and a display unit that displays the image list output by the output unit.

In a case in which the n-th thumbnail image is randomly disposed, the thumbnail image disposition unit calculates an overlapping area with n-1 thumbnail images that have already been disposed, repeats the disposition and calculation operations a predetermined number of times, determines a disposition position of the n-th thumbnail image at a position at which the overlapping area is minimized, and performs the operations for determining the disposition position on N thumbnail images.

### SUMMARY OF THE INVENTION

A case is considered in which a composite image in which a plurality of images are arranged in the layout region as described above is disclosed to the public via a social networking service (SNS) or the like. In such a case, it is desirable that the image is arranged in consideration of the intention of the user to disclose the image in order to prevent an image or a region in the image that the user does not want to disclose from being disclosed.

However, in the technique disclosed in JP2004-328711A, the image is not arranged in consideration of the intention of the user to disclose the image.

In addition, it takes a lot of time and is difficult for the user to perform the work of viewing each of a large number of images, selecting a region to be hidden in the image, and determining the arrangement of the image for hiding the region.

One embodiment of the present invention has been made in view of the above circumstances, and an object thereof is to provide an image display apparatus, an image display method, a program, and a storage medium capable of determining an appropriate image arrangement in consideration of the intention of a user to disclose an image.

In order to achieve the above object, an image display apparatus according to one embodiment of the present invention includes a processor, in which the processor is configured to: identify, for each of a plurality of images, a subject within the image; determine a selected subject from among the subjects identified for the plurality of respective images; set, for display of the plurality of images, a display layer for each image such that an image region of the selected subject in a first image including the selected subject is hidden by a second image different from the first image; and display each of the plurality of images, including the first image and the second image, on the set display layer.

In addition, the processor may be configured to: identify a plurality of types of subjects included in the plurality of images; and determine the selected subject from among the plurality of types of subjects.

In addition, the second image may be an image among the plurality of images that does not include the selected subject.

In addition, the processor may be configured to select the selected subject from among the identified subjects for each of the plurality of images based on a predetermined selection criterion.

In addition, the processor may be configured to receive, as the selected subject, a subject selected by a user from among the identified subjects for each of the plurality of images.

In addition, the processor may be configured to determine, in a case where the image region of the selected subject is present in each of two or more first images and a first image in which the image region of the selected subject is not hidden is present, the first image in which the image region of the selected subject is to be hidden from among the two or more first images based on information regarding the image region of the selected subject in each of the two or more first images.

In addition, the processor may be configured to: highlight, in a case where the image region of the selected subject is present in each of two or more first images and a first image in which the image region of the selected subject is not hidden is present in the two or more first images, the image region of the selected subject that is not hidden; receive a user selection of any of the image regions which are highlighted of the selected subject; and reset the display layer such that the image region of the selected subject selected by a user is hidden.

In addition, the processor may be configured to execute a performance of switching display or non-display of the image region of the selected subject.

In order to solve the above-described problem, an image display apparatus according to one embodiment of the present invention includes a processor, in which the processor may be configured to: apply a region-extraction model constructed by machine learning to a plurality of images and extract a target region from a target image that includes the target region from among the plurality of images; set, in a case where the target region is extracted from each of two or more target images, a tolerance for disclosure of the target region based on a characteristic of the target region extracted for each of the target images; set, for display of the plurality of images, a display layer for each image such that the target region of the target image including the target region in which a first tolerance is set is hidden by the target image including the target region in which a second tolerance higher than the first tolerance is set; and display each of the plurality of images including the two or more target images from which the target region has been extracted on the set display layer.

In addition, the target region may be a region that satisfies a non-display condition.

In addition, the processor may be configured to: acquire, for each of the two or more of the target images, as the characteristic of the target region, first information regarding at least one of a size of the target region, the number of the target regions in the target image, or a position of the target regions in the target image; and set the tolerance based on the first information.

In addition, the processor may be configured to: acquire, for each of the two or more target images, as the characteristic of the target region, second information regarding at least one of a right to disclose the target region or a scene indicated by the target region; and set the tolerance based on the second information.

In addition, the processor may be configured to set the tolerance based on a condition set by a user regarding the tolerance and the characteristic of the target region extracted for each target image.

In addition, the processor may be configured to accept a change to the tolerance for the target region which is selected, after setting the tolerance.

In addition, the processor may be configured to accept, for the target region which is selected, a change to increase the tolerance to a level higher than that at a time when the tolerance is set.

In addition, the processor may be configured to highlight, in a case where the target region is extracted from each of the two or more target images and the target image in which the target region is not hidden is present among the two or more target images, the target region which is not hidden; receive a user selection of any of the target regions which are highlighted; and reset the display layer such that the target region which is selected by a user is hidden by the target image that does not include the target region which is selected by the user.

In addition, the processor may be configured to execute a performance of switching display or non-display of the target region in which the first tolerance is set.

In order to solve the above-described problem, an image display method according to one embodiment of the present invention is characterized in that an image display method executed by a processor, the method including: identifying, for each of a plurality of images, a subject within the image; determining a selected subject from among the subjects identified for the plurality of respective images; setting, for display of the plurality of images, a display layer for each image such that an image region of the selected subject in a first image including the selected subject is hidden by a second image different from the first image; and displaying each of the plurality of images, including the first image and the second image, on the set display layer.

In order to solve the above-described problem, an image display method according to one embodiment of the present invention is characterized in that an image display method executed by a processor, the method including: applying a region-extraction model constructed by machine learning to a plurality of images and extracting a target region from a target image that includes the target region from among the plurality of images; setting, in a case where the target region is extracted from each of two or more target images, a tolerance for disclosure of the target region based on a characteristic of the target region extracted for each of the target images; setting, for display of the plurality of images, a display layer for each image such that the target region of the target image including the target region in which a first tolerance is set is hidden by the target image including the target region in which a second tolerance higher than the first tolerance is set; and displaying each of the plurality of images including the two or more target images from which the target region has been extracted on the set display layer.

Still another embodiment of the present invention relates to a program for causing a computer to execute each process included in the image display method according to claim 18 or 19.

Further, according to the embodiment of the present invention, it is possible to realize a computer-readable storage medium on which a program for causing a computer to execute each process included in the image display method according to claim 18 or 19 is stored.

According to one embodiment of the present invention, it is possible to provide an image display apparatus, an image display method, a program, and a storage medium capable of determining an appropriate image layout in consideration of the intention of a user to disclose an image.

### BRIEF DESCRIPTION OF THE DRAWINGS

FIG. 1 is a diagram showing a state in which a plurality of images are sequentially displayed in a first example of image display according to a first embodiment of the present invention.

FIG. 2 is a diagram showing a state in which an image is acquired by a user terminal by imaging a printed matter in the first example of image display according to the first embodiment of the present invention.

FIG. 3 is a diagram showing a selection screen for selecting a target image in the first example of image display according to the first embodiment of the present invention.

FIG. 4 is an explanatory diagram of a series of processes related to specifying an image region in the first example of image display according to the first embodiment of the present invention.

FIG. 5 is a diagram showing a selection screen for selecting a target image in a second example of image display according to the first embodiment of the present invention.

FIG. 6 is a diagram in which information regarding an image region of each image is compared in the second example of image display according to the first embodiment of the present invention.

FIG. 7 is a diagram showing a state in which a plurality of images are sequentially displayed in the second example of image display according to the first embodiment of the present invention.

FIG. 8 is a diagram showing a state in which an image region of a selected subject that is not hidden is emphasized in the second example of image display according to the first embodiment of the present invention.

FIG. 9 is a diagram showing a configuration example of an image display system including an image display apparatus according to the first embodiment of the present invention.

FIG. 10 is a diagram for describing a function of the image display apparatus according to the first embodiment of the present invention.

FIG. 11 is a diagram showing a procedure of an image display flow according to the first embodiment of the present invention.

FIG. 12 is a diagram for describing a function of the image display apparatus according to the second embodiment of the present invention.

FIG. 13 is an explanatory diagram of a series of processes related to setting a tolerance in an example of image display according to the second embodiment of the present invention.

FIG. 14 is an explanatory diagram of a series of processes related to setting a tolerance in another example of image display according to the second embodiment of the present invention.

FIG. 15 is an explanatory diagram of a change in the tolerance in image display according to the second embodiment of the present invention.

FIG. 16 is a diagram showing a procedure of an image display flow according to the second embodiment of the present invention.

FIG. 17 is an explanatory diagram of functions of an image display apparatus according to a modification example.

FIG. 18 is a diagram showing a procedure of an image display flow according to the modification example.

### DESCRIPTION OF THE PREFERRED EMBODIMENTS

### First Embodiment

One specific embodiment of the present invention will be described with reference to the drawings. However, the following embodiments are merely examples for ease of understanding of the present invention, and are not intended to limit the present invention. Moreover, the present invention can be modified or improved from the following embodiments without departing from the gist of the present invention. Furthermore, the present invention also includes an equivalent thereof.

In the present specification, the concept of “apparatus” includes a single apparatus that exerts a specific function and includes a combination of a plurality of apparatuses that are present independently and are distributed but operate together (cooperate) to exert a specific function.

In addition, in the present specification, the “image” is an image that is a display target and includes a subject, specifically, an image represented by digital image data.

Examples of the image data include lossy compressed image data, such as joint photographic experts group (JPEG) format, and lossless compressed image data, such as graphics interchange format (GIF) or portable network graphics (PNG) format. Further, the image data may include accessory information representing a file name, an imaging date and time, an imaging location, and the like.

In addition, in the present specification, the “user” is a user who uses the image display apparatus according to an aspect of the present invention. The meaning of using the image display apparatus is to use a function of the image display apparatus, and includes to directly operate the image display apparatus, and to use the function of the image display apparatus via a device (for example, a user terminal) that can communicate with the image display apparatus.

Further, in the present specification, “machine learning” may include a neural network, a convolutional neural network, a recurrent neural network, attention mechanisms, a transformer, a generative adversarial network, a deep-learning neural network, a Boltzmann machine, matrix factorization, a factorization machine, an M-way factorization machine, a field-aware factorization machine, a field-aware neural factorization machine, a support vector machine, a Bayesian network, a decision tree, and a random forest, as well as other types of machine learning.

### Overview of Image Display

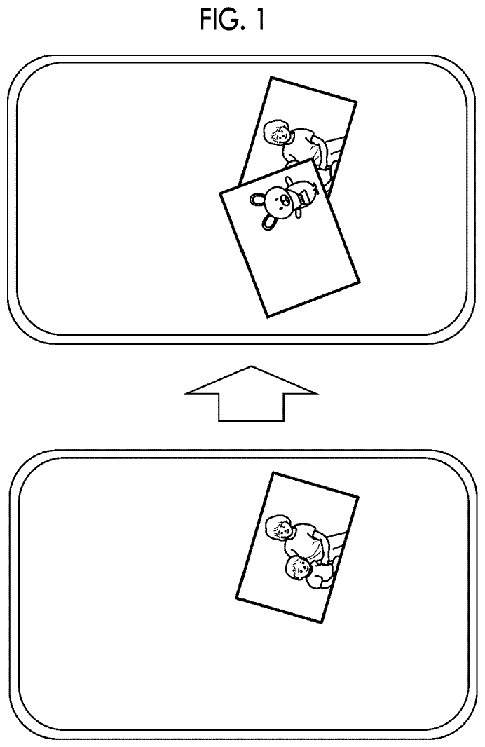

A series of processes related to image display performed using the image display apparatus according to the first embodiment of the present invention and the image display method (hereinafter, simply referred to as “image display”) will be described with reference to FIGS. 1 to 8.

In the image display, a subject included in a plurality of images is specified, a selected subject is determined from among the subjects, each display layer is set such that an image region of the selected subject is hidden by another image, and each of the plurality of images is displayed on the set display layer.

It should be noted that the image region of the selected subject is hidden in order to keep the image region from being disclosed to other people. That is, by hiding the image region of the selected subject with another image, it is possible to prevent the disclosure of an image region that the user does not want to disclose in a scene in which a composite image in which a plurality of images are arranged is distributed to the public via an SNS or the like.

In more detail, in the image display, an image (image on a side to be hidden) including an image region to be hidden and an image (image on a side to hide) that hides the image region are set to different display layers, and a display layer including the image on the side to hide is set to a higher layer than a display layer including the image on the side to be hidden. Then, in a state in which the image on the side to be hidden is displayed, the display state of the image region to be hidden is changed by switching the display and non-display of the image on the side to hide.

The image display will be described in more detail using an example of a display screen of the user terminal shown in FIG. 1. On the right display screen of FIG. 1, an image on the side to hide (image in which a parent and a child are displayed) and an image on the side to be hidden (image in which a character is displayed) are displayed, and an image region (face region of a child) of the image on the side to hide (image in which a parent and a child are displayed) is hidden by the image on the side to be hidden (image in which a character is displayed).

The image on the side to hide (image in which a parent and a child are displayed) and the image on the side to be hidden (image in which a character is displayed) are set to different display layers, and a display layer including the image on the side to hide (image in which a character is displayed) is set to a higher layer than a display layer including the image on the side to be hidden (image in which a parent and a child are displayed). Then, in a state in which the image on the side to be hidden (image in which a parent and a child are displayed) is displayed, the display or non-display of the image region (face region of a child) included in the image on the side to be hidden can be switched by switching the display or non-display of the image on the side to hide (image in which a character is displayed).

In the image display, a performance (animated display) of the display or non-display of the image region to be hidden may be executed, and in the example shown in FIG. 1, it is possible to execute a performance of switching the display and non-display of the image region (specifically, a face of a child) included in the image on the side to hide by transitioning from the left display screen to the right display screen.

The “subject” is broadly interpreted and includes, for example, a person, an object, a landscape, a character, a letter, a symbol, a number, a picture, a pattern, or the like.

The “selected subject” is a subject selected from among the subjects specified for each of the plurality of images. In the example shown in FIG. 1, for example, the child corresponds to the selected subject.

The “image region” is a part or all of a region (subject region) including the selected subject, and in the example shown in FIG. 1, a face region of the child in a subject region including the child of the selected subject corresponds to the image region.

A case in which the image display of the present invention is used corresponds to, for example, a case in which a composite image in which an image group is arranged in a layout region is distributed to the public via an SNS or the like, and an image region related to personal information, confidential information, or a right to disclose (copyright or the like) is included in any image constituting the image group.

In addition, the image display of the present invention may be used in a case in which the image region to be hidden is actually checked after the image group is arranged in the layout region, and the image including the image region is changed or the disposition relationship between the images of the image group is changed based on the check.

The “layout region” is a preset region for arranging the image group, and, for example, in the example shown in FIG. 1, the entire display screen of the user terminal corresponds to the layout region.

Hereinafter, the image display will be described in more detail using two examples.

### First Example of Image Display

The first example of the image display will be described with reference to FIGS. 1 to 4.

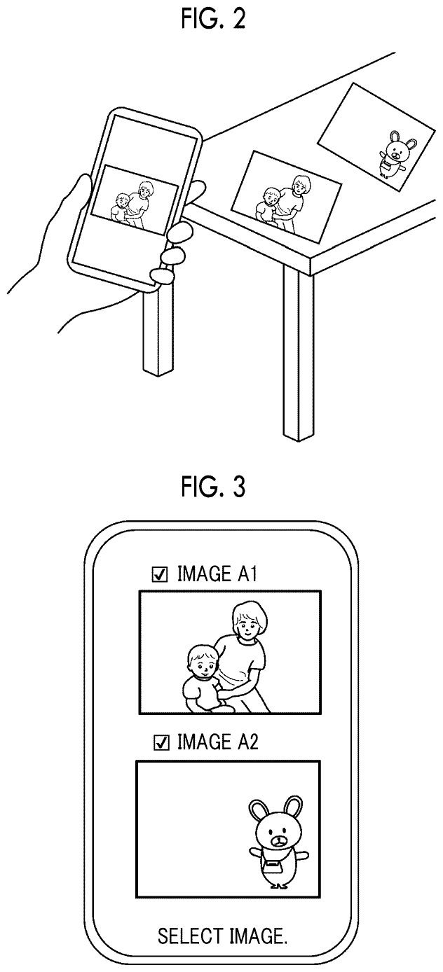

First, as shown in FIG. 2, the user captures (scans) a plurality of (two in FIG. 2) printed matters (photos) using the user terminal having a camera function and imports the plurality of images into the user terminal.

The “user terminal” is a computer used by the user, and specifically, a smart device such as a smartphone, a tablet terminal, a notebook personal computer (PC), or the like. An application program (hereinafter, an image selection application) for selecting a plurality of images for image displaying is installed in the user terminal.

The “printed material” is, for example, a photo obtained by developing a latent image recorded on a medium such as an instant film by an instant camera, or a printed material obtained by printing image data on a medium by a printer. It should be noted that the printed matter may or may not have a frame region. The frame region is a margin region that forms a rectangular frame formed along an outer edge of the printed matter, and more specifically, is a region that surrounds an inside image region including a person or the like that is a subject.

Next, the user starts the image selection application installed in the user terminal. After the image selection application is started, the display screen of the user terminal transitions to a screen on which a plurality of images to be selected are displayed as shown in FIG. 3 through a predetermined operation. In the example shown in FIG. 3, two images are displayed, specifically, an image A1 in which a parent and a child are displayed and an image A2 in which a character that is free of license, that is, a character that can be freely used by other people is displayed are displayed.

The user selects a plurality of images as images to be selected, and a series of processes of the image display are executed in response to the transmission of the selected plurality of images to the image display apparatus 10 described below.

In the image display, the selected plurality of images (images A1 and A2) are acquired, and then a subject in the image is specified for each of the plurality of images. More specifically, a plurality of types of subjects included in the plurality of images are specified.

More specifically, the plurality of images include types of subjects that are different from each other. That is, in a case in which the subjects included in each of the plurality of images to be acquired are summarized, there are two or more types of subjects.

As the types of subjects that are different from each other, for example, in a case in which the subject is a person, the same person may be set as the same type of subject, or the same person may be set as different types of subjects according to, for example, a degree of skin exposure.

In the example shown in FIG. 3, the image A1 includes two types of subjects of an adult and a child, and the image A2 includes one type of subject of a character that is free of license. That is, three types of subjects are specified as the plurality of types of subjects included in the plurality of images.

Next, in the image display, the selected subject is determined from among the plurality of types of subjects specified for each of the plurality of images.

The selected subject is determined from among the subjects specified for each of the plurality of images based on, for example, a preset selection criterion.

Examples of the “preset selection criterion” include the presence or absence of personal information, confidential information, or a right to disclose, and examples of the selected subject include a child, a character whose use is restricted by copyright or the like, and a character string such as a name, an address, and a date of birth of a person. For example, in a case in which character information indicating a name is included in an imaging image by writing the name by hand on the printed matter and imaging the printed matter, the character information may correspond to the selected subject.

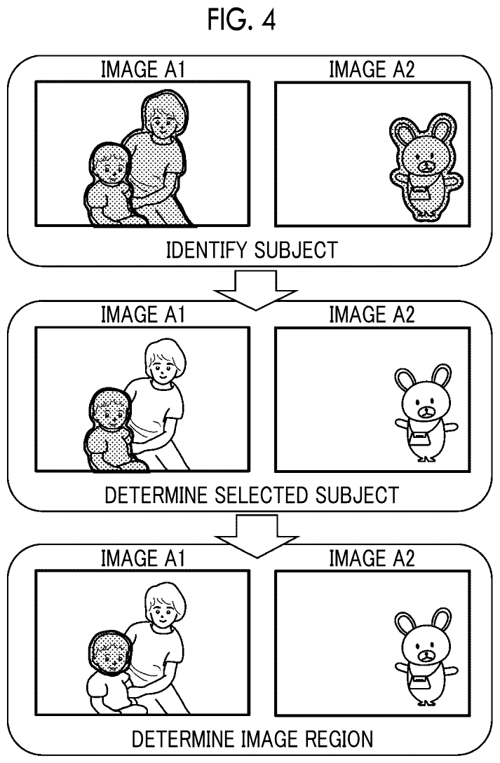

In the example shown in FIG. 4, one type of selected subject, specifically, a subject of a child in the image A1 is selected as the selected subject from among the three types of subjects.

In addition, the selected subject may be received as the selected subject by receiving, as the selected subject, a subject selected by the user from among the subjects specified for each of the plurality of images.

More specifically, information regarding the specified subject is transmitted to the user terminal, the information regarding the specified subject is presented to the user through the display screen of the user terminal, and the user is caused to select the selected subject. In a case in which the selected subject is selected, information regarding the selected subject is transmitted from the user terminal, and the subject selected by the user is received as the selected subject.

Examples of the “information regarding the subject” include a keyword indicating the subject, an image in which a subject region is emphasized with a marker or the like in an original image including the subject, and a thumbnail image of the subject.

In addition, the selected subject may be selected by, for example, a selection model (trained model) constructed by machine learning. The selection model is constructed by performing machine learning using learning data including a sample image of the subject and information (correct answer information) indicating a selection result.

Next, in the image display, the image region is determined from a region (subject region) including the selected subject.

The image region may be determined from the subject region including the selected subject based on the preset selection criterion, and for example, in a case in which the selected subject is a child, a face region of the child corresponds to the image region, and in a case in which the selected subject is a character, an entire region of the character corresponds to the image region.

In the example shown in FIG. 4, the face region of the child displayed in the image A1 corresponds to the image region.

Next, in the image display, one or two or more images including the selected subject among the plurality of images are determined as first images, and the other images, for example, images among the plurality of images that do not include the selected subject are determined as second images.

In the example shown in FIG. 4, the image A1 including the child that is the selected subject corresponds to the first image, and the image A2 not including the child that is the selected subject corresponds to the second image.

Next, in the image display, the display layer of each image in a case of displaying the plurality of images is set such that the image region of the first image is hidden by the second image.

More specifically, in the display layer of each image in a case of displaying the plurality of images, a display layer including the first image and a display layer including the second image are set to be different display layers from each other, and the display layer including the second image is set to be positioned on a higher layer than the display layer including the first image.

In the example shown in FIG. 1, a display layer including the image A1 corresponding to the first image and a display layer including the image A2 corresponding to the second image are set to be different display layers from each other, and the display layer including the image A2 is set to be positioned on a higher layer than the display layer including the image A1.

Next, in the image display, each of the plurality of images including the first image and the second image is displayed on the set display layer.

In the example shown in FIG. 1, in the left display screen of FIG. 1, the image A1 is displayed, and in the right display screen of FIG. 1, both the image A1 and the image A2 are displayed.

In the left display screen of FIG. 1, since the second image is not displayed, the face region of the child corresponding to the image region is displayed. On the other hand, in the right display screen of FIG. 1, since the first image and the second image are displayed, the face region of the child corresponding to the image region is not displayed. That is, the display or non-display of the face region of the child corresponding to the image region is switched in response to the switching of the display or non-display of the second image.

In the example shown in FIG. 1, a performance (animated display) of the display or non-display of the face region of the child corresponding to the image region is executed, and more specifically, a performance of switching the display or non-display of the face region of the child corresponding to the image region is executed by transitioning from the left display screen of FIG. 1 to the right display screen.

Thereafter, the user checks the image region to be hidden, and then operates the display screen of the user terminal to click a button for image generation (not shown). As a result, in the image display, a composite image in which the plurality of images are combined is generated. For example, in the example shown in FIG. 1, a composite image consisting of a plurality of images as shown in the right display screen of FIG. 1 is generated.

As a result, the series of processes of the image display ends.

It should be noted that, for convenience of description, the first example shows only two images (images A1 and A2). However, the present invention is not limited to this, and the series of processes of the image display may be executed using three or more images, and for example, the plurality of images may include a plurality of first images and a plurality of second images.

In addition, in the first example, one image is set on one display layer, but the present invention is not limited to this, and for example, in a case in which the series of processes of the image display are executed using three or more images, two or more images may be set on one display layer. That is, in a case in which the first image including the image region on the side to be hidden and the second image on the side to hide the image region are set to different display layers, a plurality of images may be set on the same display layer.

### Second Example of Image Display

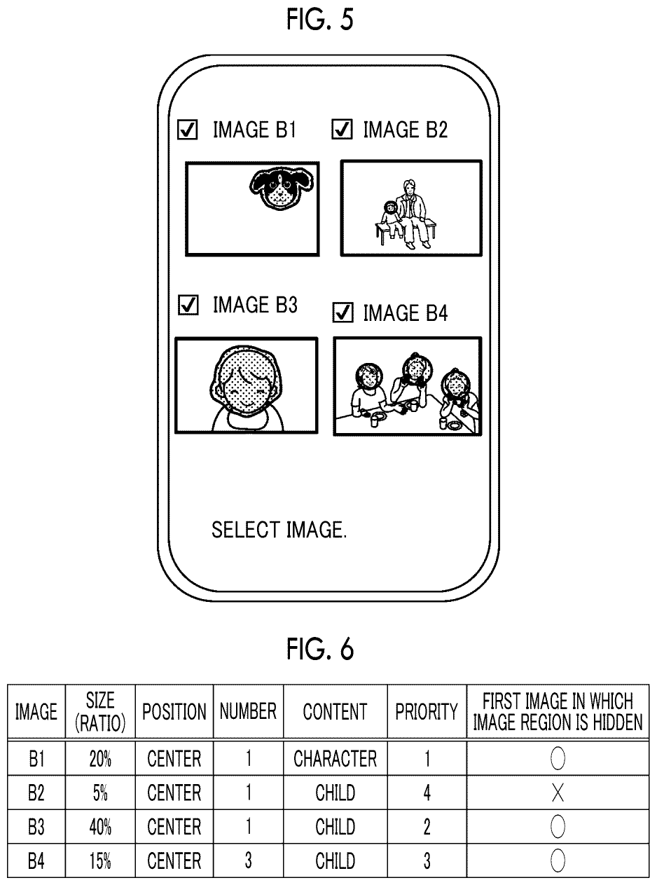

Next, the second example of the image display will be described with reference to FIGS. 5 to 8.

The second example shows an example of a case in which the image region of the selected subject is present in each of two or more first images and there is a first image in which the image region of the selected subject is not hidden.

Hereinafter, a case in which four images are selected on the selection screen of the user terminal shown in FIG. 5 will be specifically described.

It should be noted that the four images are an image B1 in which a character for which a right to disclose (copyright or the like) is set is displayed, an image B2 in which a parent and a child are displayed, an image B3 in which a face of a child is displayed large, and an image B4 in which a plurality (three) of children are displayed.

In this case, since the image region (the character region or the face region of the child, see a region surrounded by a solid line in FIG. 5) of the selected subject is present in each of the images B1 to B4, each of the images B1 to B4 corresponds to the first image.

That is, in the second example of the image display, all of the acquired plurality (four) of images are the first images, the second image does not exist, and the image region that is a part or all of the subject region including the selected subject is present in each of the four first images. Therefore, all of the first images cannot be hidden, and at least one of the images B1 to B4 corresponds to the first image in which the image region of the selected subject is not hidden.

It should be noted that, in FIG. 5, for convenience of description, the image region of the selected subject is emphasized by being surrounded by a solid line on the display screen of the user terminal, but it is not emphasized on the actual display screen.

In the image display, a first image in which the image region of the selected subject is hidden among the two or more first images is determined based on information regarding the image region of the selected subject in each of the two or more first images.

Examples of the “information regarding the image region” include a size (ratio) of the image region with respect to the image, a position of the image region with respect to the image, the number of image regions, and a display content of the image region.

More specifically, as shown in FIG. 6, a priority of the images B1 to B4 is set based on each item of the information regarding the image region. In the example shown in FIG. 6, the image B1 is a character for which a right to disclose (copyright or the like) is set, and thus has a higher priority than the face region of the child, the ratio of the face region of the child in the image B2 is the lowest, the ratio of the face region of the child in the image B3 is the highest, and the number of face regions of the child in the image B4 is the largest.

The priorities of the images B1 to B4 are set based on the information regarding the image region as described above, and as shown in FIG. 6, three images B1, B3, B4 other than the image B2 having the lowest priority are determined as the first images in which the image region is hidden.

Next, in the image display, the display layer of each image in a case of displaying the plurality of images is set such that the image region of the first image is hidden by another first image.

In the second example of the image display, each of the images B1 to B4 corresponding to the first images is set to a different display layer such that the image regions of the three first images (images B1, B3, B4) other than the image B2 having the lowest priority are hidden by another first image.

The disposition positions of the three images B1, B3, B4 on each display layer are determined based on, for example, the information regarding the image region of the selected subject.

More specifically, as shown in FIG. 6, the first image having a higher priority is set to a lower display layer in accordance with the priority order set based on the information on the image region. That is, among the three images B1, B3, B4, the image B1 having the highest priority is set for the display layer that is the lowest layer, the image B3 having the second priority is set for the display layer that is higher than the display layer including the image B1, and the image B4 having the third priority is set for the display layer that is higher than the display layer including the image B3.

Further, the image B2 corresponding to the first image in which the image region is not hidden is set for the display layer that is higher than the display layer including the image B4.

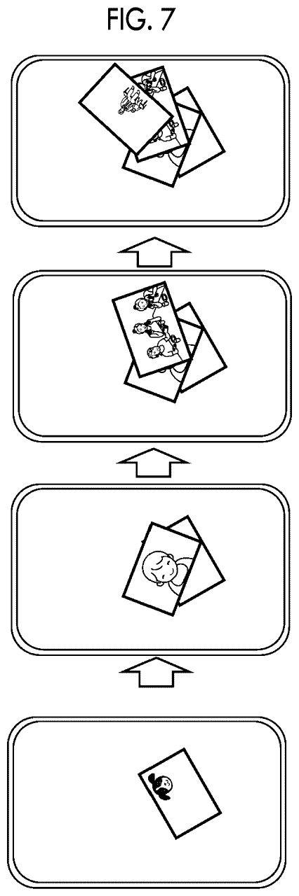

In other words, as shown in FIG. 7, the display layer of each image in a case of displaying the plurality of images is set such that the image region (character region) of the image B1 is hidden by the image B3, the image region (face region of the child) of the image B3 is hidden by the image B4, and the image region (face region of the child) of the image B4 is hidden by the image B2.

Then, it is possible to execute a performance (animated display) of sequentially hiding the image regions of the first images by sequentially transitioning from the left display screen of FIG. 7 to the right display screen.

It should be noted that, in the image display, the image region of the selected subject that is not hidden may be emphasized.

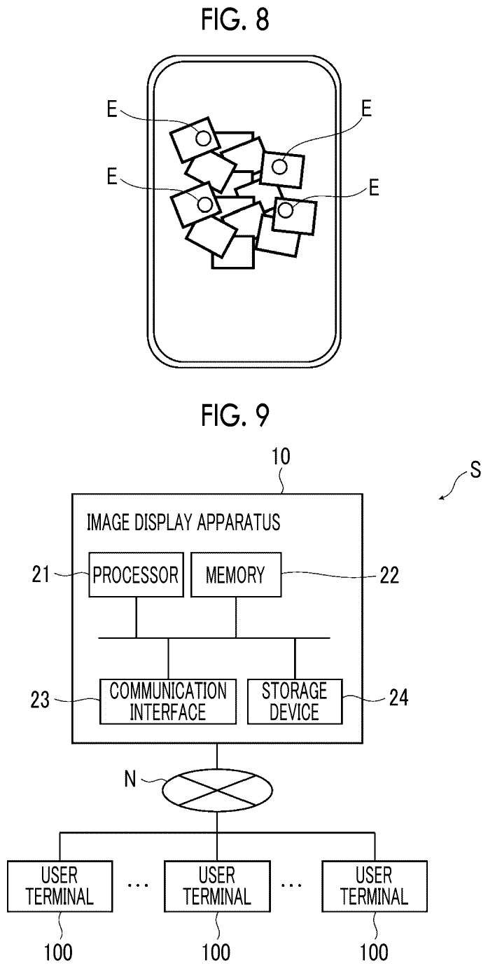

Although not shown in FIGS. 5 to 7, for example, in the rightmost display screen of FIG. 7, the image region of the selected subject that is not hidden, that is, the face region of the child corresponding to the image region of the image B2 may be emphasized on the display screen. As an example of the emphasis display, for example, as shown in FIG. 8, the image region E to be emphasized may be surrounded by a solid line. However, the present invention is not limited to this, and any display form may be used as long as the image region is conspicuous.

Next, in the image display, a selection of the user for any image region of the emphasized image region of the selected subject is received. Then, the display layer is re-set such that the image region of the selected subject selected by the user is hidden.

In the example shown in FIGS. 5 to 7, for example, in a case in which the user selects the image region of the image B2, the display layer is re-set such that the image region of the image B2 is hidden by another first image (B1, B3, B4).

Specifically, for example, the image B2 selected by the user is set for the display layer that is the lowest layer. The other images B1, B3, B4 are set to the display layers that are higher than the display layer including the image B2, and specifically, the first image having a higher priority is set to a display layer that is lower, according to the priority set based on the information regarding the image region shown in FIG. 6.

More specifically, the display layer of each image in a case of displaying the plurality of images is set such that the image region (face region of the child) of the image B2 is hidden by the image B1, the image region (character region) of the image B1 is hidden by the image B3, and the image region (face region of the child) of the image B3 is hidden by the image B4.

In this case, the image B4 corresponds to the first image in which the image region of the selected subject is not hidden.

Thereafter, the user checks the image region to be hidden, and then operates the display screen of the user terminal to click a button for image generation (not shown). As a result, a composite image in which the plurality of images are combined is generated.

As a result, the series of processes of the image display ends.

It should be noted that, in the second example of the image display, an example has been described in which only a plurality of first images are present as the plurality of images, but the present invention is not limited to this, and the plurality of images may include a second image.

That is, even in a case in which the plurality of images include the second image, the second example applies in a case in which there is a first image in which the image region of the selected subject is not hidden.

### Configuration Example of Image Display System According to First Embodiment

A configuration of an image display system (hereinafter, referred to as “image display system S”) including the image display apparatus according to the first embodiment will be described with reference to FIG. 9.

As shown in FIG. 9, the image display system S is configured by the image display apparatus 10 and a plurality of user terminals 100. The image display apparatus 10 and the plurality of user terminals 100 are communicably connected to each other through a network N.

The image display apparatus 10 is configured by a server computer. The image display apparatus 10 may be configured by one server computer or a plurality of server computers that are distributed in parallel. In addition, the server computer constituting the image display apparatus 10 may be a server computer for an application service provider (ASP), software as a service (SaaS), platform as a service (PaaS), or infrastructure as a service (IaaS). In a case where necessary information is input to the user terminal 100, the above-described server computer executes various types of processing (operations) based on the input information, and an operation result is output on the user terminal 100 side. Consequently, a function of the server computer, which is the image display apparatus 10, can be used on the user terminal 100 side.

As shown in FIG. 9, the computer constituting the image display apparatus 10 includes a processor 21, a memory 22, a communication interface 23, and a storage device 24.

The processor 21 is configured by, for example, a central processing unit (CPU), a micro-processing unit (MPU), a micro controller unit (MCU), a graphics processing unit (GPU), a digital signal processor (DSP), a tensor processing unit (TPU), an application-specific integrated circuit (ASIC), or the like.

The memory 22 is configured by, for example, a semiconductor memory such as a read-only memory (ROM) and a random-access memory (RAM). A program (hereinafter, image display program) for executing the image display is stored in the memory 22. The image display program is a program for causing the processor 21 to execute each process of the image display method described later. The image display program may be acquired by being read from a computer-readable storage medium, or may be acquired by being downloaded through a communication network such as the Internet or an intranet.

The communication interface 23 may be configured by, for example, a network interface card or a communication interface board. The computer constituting the image display apparatus 10 is able to communicate with another device connected to the Internet, a mobile communication line, or the like via the communication interface 23.

The storage device 24 is configured by, for example, a flash memory, a hard disc drive (HDD), a solid-state drive (SSD), a flexible disc (FD), a magneto-optical disc (MO disc), a compact disc (CD), a digital versatile disc (DVD), a secure digital card (SD card), a universal serial bus memory (USB memory), or the like. It should be noted that the storage device 24 may be built in a computer body constituting the image display apparatus 10 or may be mounted on the computer body in an external format.

The user terminal 100 comprises a processor, a memory, a communication interface, a camera, an input device, and an output device.

### Functions of Image Display Apparatus According to First Embodiment

Next, the configuration of the image display apparatus 10 according to the first embodiment of the present invention will be described again from the functional aspect.

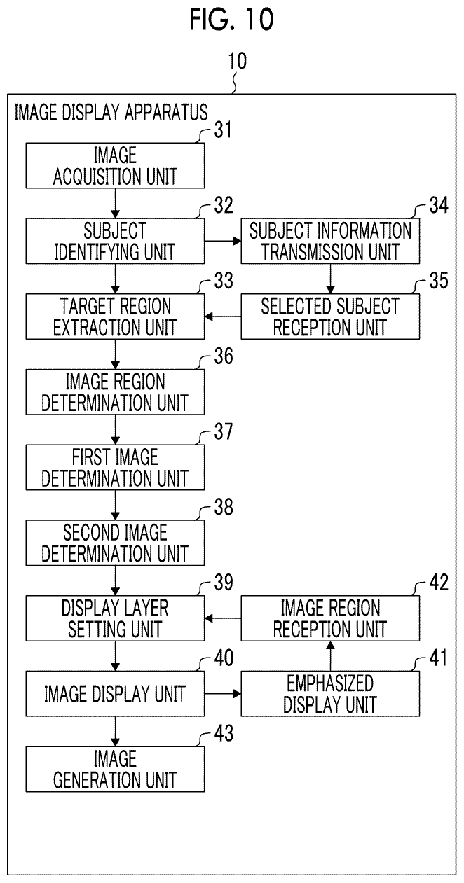

As shown in FIG. 10, the image display apparatus 10 includes an image acquisition unit 31, a subject identifying unit 32, a selected subject determination unit 33, a subject information transmission unit 34, a selected subject reception unit 35, an image region determination unit 36, a first image determination unit 37, a second image determination unit 38, a display layer setting unit 39, an image display unit 40, an emphasis display unit 41, an image region reception unit 42, and an image generation unit 43.

These functional sections are implemented by the cooperation between the hardware device included in the computer constituting the image display apparatus 10 and the program (that is, software) installed in the computer.

Hereinafter, each of the functional units will be described.

### Image Acquisition Unit

The image acquisition unit 31 acquires a plurality of images transmitted from the user terminal 100. More specifically, the user selects a plurality of images to be subjected to the image displaying on an operation screen of the user terminal 100, the plurality of images selected from the user terminal 100 are transmitted from the user terminal 100 by the user, and thus the image acquisition unit 31 receives and acquires the plurality of images via the network N.

The plurality of images transmitted from the user terminal 100 may be an image captured (scanned) by the camera function of the user terminal 100, or may be an image acquired by the user terminal 100 from another user terminal 100 or the like by communicating with another user terminal or the like via the network N. That is, the image may be an image acquired from the outside, for example, an image that is disclosed on an SNS or an image shared from an acquaintance.

### Subject Identifying Unit

The subject identifying unit 32 specifies a subject in the image for each of the acquired plurality of images. More specifically, the subject identifying unit 32 specifies a plurality of types of subjects included in the plurality of images.

Specifically, the subject identifying unit 32 specifies one subject for each image, or specifies a plurality of subjects from one image among the plurality of images.

For example, a known subject detection technology and a subject identification technology can be used for the specification (detection) of the subject.

### Selected Subject Determination Unit

The selected subject determination unit 33 determines the selected subject from among the subjects specified for each of the plurality of images, more specifically, from among the plurality of types of subjects.

The selected subject determination unit 33 determines the selected subject from among the subjects specified for each of the plurality of images based on, for example, a preset selection criterion.

Alternatively, the selected subject determination unit 33 may determine the selected subject based on information regarding the selected subject received by the selected subject reception unit 35 described below.

In addition, the selected subject determination unit 33 may determine the selected subject by a selection model (trained model) constructed by machine learning.

### Subject Information Transmission Unit

The subject information transmission unit 34 transmits information regarding the subject specified by the subject identifying unit 32 to the user terminal 100. The user obtains information regarding the specified subject through the display screen of the user terminal.

### Selected Subject Receiving Unit

The selected subject reception unit 35 receives, as the selected subject, a subject selected by the user from among the subjects specified for each of the plurality of images.

Examples of the subject selected by the user include a person, an object, a landscape, a character, a letter, a symbol, a number, a picture, a pattern, or the like, and in a case in which the subject is a person, a child corresponds to the selected subject.

### Image Region Determination Unit

The image region determination unit 36 determines the image region from the subject region including the selected subject.

It should be noted that the image region is determined from the subject region of the selected subject in order to determine a region to be hidden in a case in which it is not necessary to hide the entire region of the selected subject and it is sufficient to hide at least a part of the selected subject.

For example, in a case in which the selected subject is a child, the image region determination unit 36 may determine a face region of the child as the image region.

On the other hand, for example, in a case in which the selected subject is a character for which a right related to disclosure (copyright or the like) is set, the image region determination unit 36 determines the entire region of the character as the image region. That is, in a case in which the selected subject is a character for which a right related to disclosure (copyright or the like) is set, it is desirable to hide the entire region of the character.

As described above, the image region determination unit 36 may automatically determine the range of the image region with respect to the subject region according to the type of the selected subject. The image region determination unit 36 may determine the range of the image region from the region of the selected subject based on, for example, a look-up table (hereinafter, also referred to as LUT) in which a correspondence relationship between the type of the selected subject and the range of the image region is set in advance.

### First Image Determination Unit

The first image determination unit 37 determines an image including the selected subject among the plurality of images as the first image.

In addition, in a case in which the image region of the selected subject is present in each of two or more first images and there is a first image in which the image region of the selected subject is not hidden, the first image determination unit 37 determines, based on information regarding the image region of the selected subject in each of the two or more first images, a first image in which the image region of the selected subject is hidden among the two or more first images.

Specifically, the first image determination unit 37 first specifies a first image in which the image region of the selected subject is not hidden based on information regarding the image region of the selected subject in each of the two or more first images.

More specifically, the first image determination unit 37 sets a priority for each of the two or more first images based on a size (ratio) of the image region with respect to the image, a position of the image region with respect to the image, the number of image regions, a display content of the image region, and the like, as shown in FIG. 6, and specifies the first image in which the image region of the selected subject is not hidden.

Then, the first image determination unit 37 determines the first image in which the image region of the selected subject is hidden as the first image other than the specified first image.

### Second Image Determination Unit

The second image determination unit 38 determines an image other than the first image, for example, an image that does not include the selected subject among the plurality of images, as the second image.

### Display Layer Setting Unit

The display layer setting unit 39 sets the display layer of each image in a case of displaying the plurality of images such that the image region of the selected subject in the first image is hidden by at least one of another first image or the second image in a case in which there are two or more first images.

In addition, in a case in which the image region reception unit 42 described below receives the selection of the image region by the user, the display layer setting unit 39 re-sets the display layer such that the image region of the selected subject selected by the user is hidden.

### Image Display Unit

The image display unit 40 displays each of the first image or a plurality of images including both the first image and the second image on the set display layer.

For example, as shown in FIG. 1, the image display unit 40 executes a performance of switching the display and non-display of the image region (specifically, the face region of the child) included in one image by transitioning from the left display screen of FIG. 1 to the right display screen.

In addition, for example, as shown in FIG. 7, in a case in which only the plurality (four) of first images are displayed, the image display unit 40 executes a performance of sequentially hiding the image regions of the first images by sequentially transitioning from the left display screen of FIG. 7 to the right display screen.

### Emphasis Display Unit

In a case in which the image region of the selected subject is present in each of two or more first images and there is a first image in which the image region of the selected subject is not hidden in the two or more first images, the emphasis display unit 41 emphasizes the image region of the selected subject that is not hidden.

For example, as shown in FIG. 8, the emphasis display unit 41 emphasizes the image region of the selected subject that is not hidden by surrounding the image region with a solid line.

### Image Region Receiving Unit

The image region reception unit 42 receives a selection of the user for any image region of the emphasized image region of the selected subject.

Examples of the image region selected by the user include a face region of a child or a character region.

### Image Generation Unit

The image generation unit 43 generates a composite image in which a plurality of images are arranged in a layout region. The image generation unit 43 generates the composite image in response to an instruction to generate the image from the user terminal 100.

### Image Display Flow According to First Embodiment

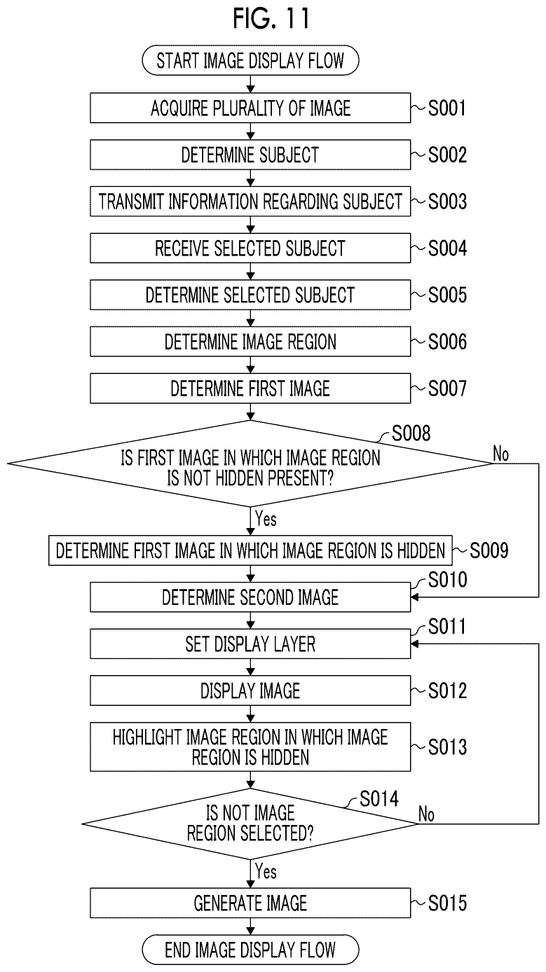

Next, the image display flow, which is a data processing flow using the above-mentioned image display apparatus 10, will be described. The image display flow adopts the image display method according to the embodiment of the present invention and proceeds in accordance with the flow shown in FIG. 11. That is, each step in the flow shown in FIG. 11 corresponds to each element constituting the image display method according to the embodiment of the present invention.

It should be noted that the flow shown in FIG. 11 is merely an example, and an unnecessary step may be removed or a new step may be added within a scope not departing from the gist of the present invention.

First, in a case where the user starts the image selection application installed in the user terminal 100, a signal generated in conjunction with the start of the application is transmitted to the server computer constituting the image display apparatus 10. The image display flow is started in response to the transmission of the signal.

In a case where a plurality of target images are transmitted from the user terminal 100, the processor 21 acquires the plurality of target images (S001). Next, the processor 21 specifies a subject in the image for each of the acquired plurality of images (S002). More specifically, the processor 21 specifies a plurality of types of subjects included in the plurality of images.

Next, the processor 21 transmits information regarding the subject specified for each of the plurality of images to the user terminal 100 (S003). Thereafter, the processor 21 receives, as the selected subject, a subject selected by the user from among the subjects specified for each of the plurality of images (S004).

Next, the processor 21 determines the selected subject from among the subjects specified for each of the plurality of images (S005). More specifically, the processor 21 sets the subject received in step S004 as the selected subject.

It should be noted that the processor 21 may determine the selected subject from among the subjects specified for each of the plurality of images based on a preset selection criterion without performing steps S003 and S004, or may determine the selected subject by a selection model (trained model) constructed by machine learning.

Next, the processor 21 determines the image region from the subject region including the selected subject (S006).

Thereafter, the processor 21 determines an image including the selected subject among the plurality of images as the first image (S007). It should be noted that, in the image display flow, the processor 21 determines two or more images among the plurality of images as the first images.

Next, the processor 21 determines whether or not the image region of the selected subject is present in each of the two or more first images and there is a first image in which the image region of the selected subject is not hidden (S008).

In a case in which it is determined that there is a first image in which the image region of the selected subject is not hidden, the processor 21 determines, based on information regarding the image region of the selected subject in each of the two or more first images, a first image in which the image region of the selected subject is hidden among the two or more first images (S009).

In a case in which it is determined that there is no first image in which the image region of the selected subject is not hidden, that is, in a case in which it is determined that the image region of all the first images is hidden by another image, the processor 21 skips step S009 and proceeds to step S010.

Next, the processor 21 determines an image other than the first image, for example, an image that does not include the selected subject among the plurality of images, as the second image (S010).

Thereafter, the processor 21 sets the display layer of each image in a case of displaying the plurality of images such that the image region of the selected subject in the first image is hidden by at least one of another first image or the second image (S011).

Next, the processor 21 displays each of the first image or the plurality of images including both the first image and the second image on the set display layer (S012).

Thereafter, in a case in which the image region of the selected subject is present in each of the two or more first images and there is a first image in which the image region of the selected subject is not hidden in the two or more first images, the processor 21 emphasizes the image region of the selected subject that is not hidden (S013).

Next, the processor 21 receives a selection of the user for any image region of the emphasized image region of the selected subject, and in a case in which it is determined that there is no selection by the user (S014), the processor 21 generates a composite image consisting of the plurality of images (S015).

On the other hand, in a case in which it is determined that there is a selection by the user (S014), the processor 21 returns to step S011 and re-sets the display layer such that the image region of the selected subject selected by the user is hidden. The processor 21 repeats the execution of steps S011 to S014 until it is determined that there is no selection by the user.

The image display flow ends immediately at a time point at which the series of processing hitherto described ends.

### Effectiveness of First Embodiment

In a case in which a composite image in which a plurality of images are arranged in a layout region is created, it takes a lot of time and is difficult for the user to perform the work of viewing each of a large number of images, selecting a region to be hidden in the image, and determining the arrangement of the image for hiding the image region.

On the other hand, in the image display apparatus 10 according to the embodiment of the present invention, the processor is configured to: specify a subject in the image for each of the plurality of images; determine a selected subject from among the subjects specified for each of the plurality of images; and set the display layer of each image in a case of displaying the plurality of images such that the image region of the selected subject in the first image is hidden by another first image or the second image. As a result, it is possible to determine an appropriate image arrangement for hiding the image region of the selected subject to be hidden regardless of the work of the user.

In addition, in the image display apparatus 10 according to the embodiment of the present invention, each of the first image or the plurality of images including both the first image and the second image is displayed on the set display layer. As a result, the user can check the image region of the selected subject that is hidden by another image by selecting the display layer.

As described above, in the image display apparatus 10, it is possible to determine an appropriate image arrangement in consideration of the intention of the user to disclose the image.

In addition, the processor 21 executes a performance of switching the display or non-display of the image region of the selected subject.

According to the above configuration, it is possible to easily check the image region that is hidden by another image.

In addition, in a case in which the image region of the selected subject is present in each of the two or more first images and there is a first image in which the image region of the selected subject is not hidden in the two or more first images, the processor 21 emphasizes the image region of the selected subject that is not hidden. Then, a selection of the user for any image region of the emphasized image region of the selected subject is received, and the display layer is reset such that the image region of the selected subject selected by the user is hidden.

According to the above configuration, the intention of the user to disclose the image can be directly reflected in the layout of the image.

### Second Embodiment

In the image display apparatus 10 according to the first embodiment, a subject included in a plurality of images is specified, a selected subject is determined from among the subjects, each display layer is set such that an image region of the selected subject is hidden by another image, and each of the plurality of images is displayed on the set display layer.

However, the present invention is not limited to this, and for example, in an image display apparatus 10A according to a second embodiment, a target region is extracted from a plurality of images by using a region-extraction model (trained model), a tolerance for disclosure of the target region is set based on a feature of the extracted target region, each display layer is set such that the target region of the image is hidden by another image according to the tolerance, and each of the plurality of images is displayed on the set display layer.

### Configuration Example of Image Display System According to Second Embodiment

An image display system including the image display apparatus 10A according to the second embodiment has the same configuration as the image display system S according to the first embodiment, and the image display apparatus 10A is configured by a server computer as in the image display apparatus 10, and includes a processor 21A, a memory, a communication interface, and a storage device.

### Functions of Image Display Apparatus According to Second Embodiment

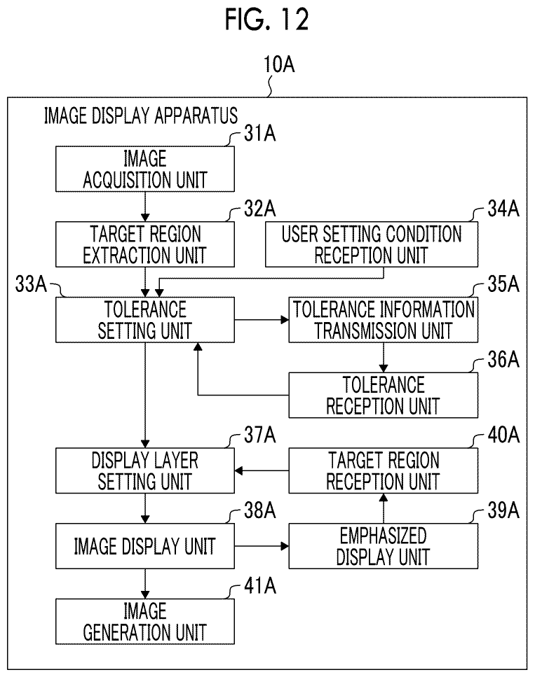

As shown in FIG. 12, the image display apparatus 10A includes an image acquisition unit 31A, a target region extraction unit 32A, a tolerance setting unit 33A, a user setting condition reception unit 34A, a tolerance information transmission unit 35A, a tolerance reception unit 36A, a display layer setting unit 37A, an image display unit 38A, an emphasis display unit 39A, a target region reception unit 40A, and an image generation unit 41A.

These functional sections are implemented by the cooperation between the hardware device included in the computer constituting the image display apparatus 10A and the program (that is, software) installed in the computer.

Hereinafter, each of the functional units will be described.

### Image Acquisition Unit

The image acquisition unit 31A acquires a plurality of images transmitted from the user terminal 100. It should be noted that the image acquisition unit 31A has the same functions as the image acquisition unit 31 according to the first embodiment, and thus detailed description thereof will be omitted.

### Target Region Extraction Unit

The target region extraction unit 32A applies a region-extraction model constructed by machine learning to a plurality of images to extract a target region from a target image including the target region among the plurality of images.

The “target region” is a region satisfying a non-display condition, that is, a region (restricted disclosure region) in the image in which disclosure is restricted. It should be noted that the target region may include a region other than the restricted disclosure region, and for example, may include a part or all of a subject region other than the restricted disclosure region.

Examples of the target region include a face region of a child, a character region whose use is restricted by copyright or the like, and a region including a character string such as a name, an address, and a date of birth of a person. For example, in a case in which character information indicating a name is included in an imaging image by writing the name by hand on the printed matter and imaging the printed matter, a region indicating the character information may correspond to the target region.

The “target image” means an image including the target region among the plurality of images.

It should be noted that an image (non-target image) that does not include the target region is arranged at a position that hides the target region of the target image in the layout region, or is arranged at a position away from the target image without hiding the target region of the target image.

Hereinafter, the description will be made on the premise that all of the plurality of images are the target images.

The “region-extraction model” is constructed by performing machine learning using learning data including a plurality of sample images including at least one or more subjects and information (correct answer information) indicating a target region in the sample image.

### Tolerance Setting Unit

In a case in which the target region is extracted from each of two or more target images, the tolerance setting unit 33A sets a tolerance for disclosure of the target region based on a feature of the target region extracted for each target image.

More specifically, the tolerance setting unit 33A acquires first information regarding at least one of a size of the target region, the number of target regions in the target image, or a position of the target region in the target image, as a feature of the target region, for each of the two or more target images.

Examples of the “size of the target region” include an area of the target region and a ratio of the area of the target region to the target image.

Examples of the “number of target regions in the target image” include the number of face regions of a child in the target image in a case in which the face region of the child corresponds to the target region.

The “position in the target image” is a position of the target region in the target image, and for example, a center portion or an end portion of the target image corresponds thereto.

In addition, the tolerance setting unit 33A acquires second information regarding at least one of a right to disclose the target region or a scene indicated by the target region, as a feature of the target region, for each of the two or more target images.

Examples of the “right to disclose the target region” include a copyright or the like of a character, a pattern, or the like included in the target region.

Examples of the “scene indicated by the target region” include an unpleasant scene, a harmful scene, and a scene of political activity such as supporting a specific political group.

More specifically, the tolerance setting unit 33A analyzes the target image by using, for example, a known image analysis technology, specifies a feature amount of the target image, and acquires at least one of the first information or the second information based on the specified feature amount.

Next, the tolerance setting unit 33A sets the tolerance for disclosure of the target region based on at least one of the first information or the second information.

The “tolerance” may be set to, for example, 0% to 100%, the tolerance of 0% is set for a target region for which disclosure is prohibited, and the tolerance of 100% is set for a target region that may be freely disclosed to a third party or a target region that is actively disclosed.

In addition, the tolerance setting unit 33A may set the tolerance based on a condition set by the user for the tolerance and the feature of the target region extracted for each target image.

More specifically, the tolerance setting unit 33A may set the tolerance for each target image based on a condition set by the user for the tolerance and at least one of the first information or the second information.

Examples of the “condition set by the user” include a tolerance set for disclosure of a child of the user himself/herself in a case in which the user is a parent.

The condition set by the user is received by the user setting condition reception unit 34A described below.

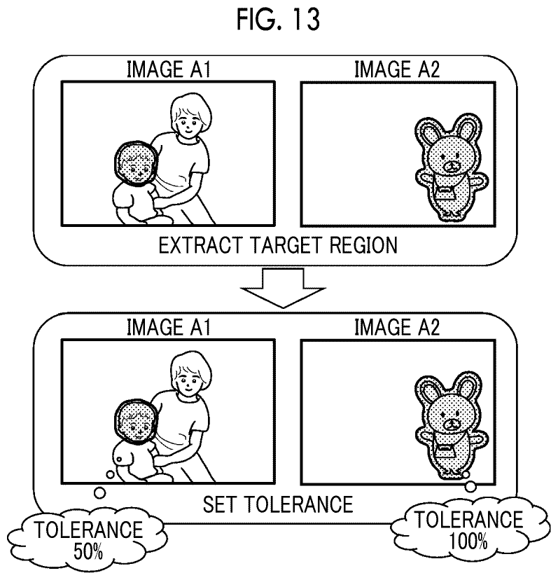

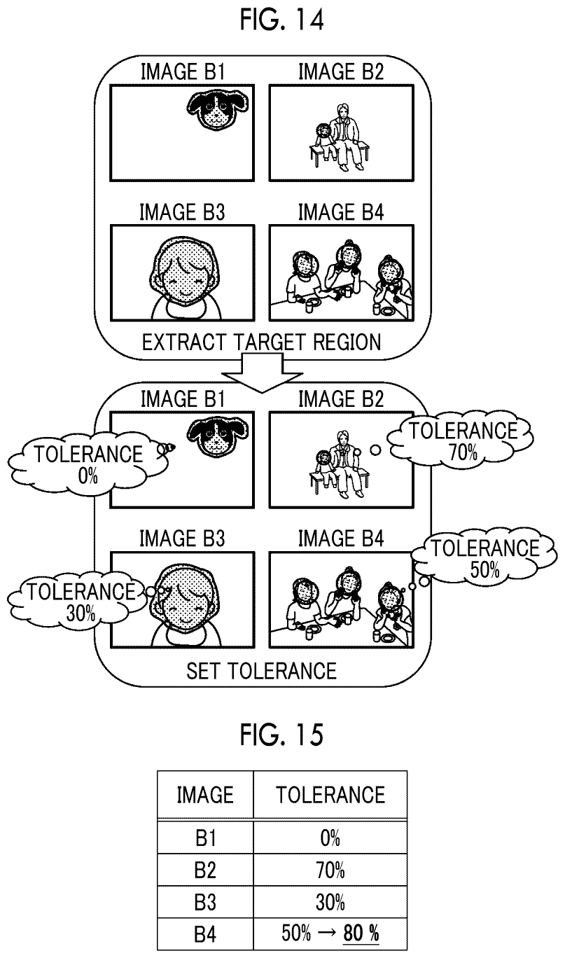

Next, the tolerance will be described in more detail with reference to FIGS. 13 and 14.

In the example shown in FIG. 13, the images A1 and A2 illustrated in the first example (see FIGS. 1 to 4) of the image display according to the first embodiment are used as the target images.

First, the target region extraction unit 32A applies the region-extraction model to each of the images A1 and A2 to extract the target region.

In the image A1, the face region of the child is extracted as the target region, and in the image A2, the entire region of the character that can be freely used by other people is extracted as the target region.

Next, the tolerance setting unit 33A sets the tolerance for disclosure of the target region based on the feature of the target region extracted for each target image.

In the example shown in FIG. 13, for the face region of the child in the image A1, for example, 50% is set as the tolerance based on the first information, that is, the size of the target region, the number of target regions in the target image, or the position of the target region in the target image.

On the other hand, for the character region in the image A2, 100% is set as the tolerance based on the second information, that is, the right to disclose the target region.

In the example shown in FIG. 14, the images B1 to B4 illustrated in the second example (see FIGS. 5 to 8) of the image display according to the first embodiment are used as the target images.

First, the target region extraction unit 32A applies the region-extraction model to each of the images B1 to B4 to extract the target region.

In the image B1, the entire region of the character for which a right related to disclosure (copyright or the like) is set is extracted as the target region, in the images B2 and B3, the face region of one child positioned at the center of the image is extracted as the target region, and in the image B4, the face region of each of three children positioned at the center of the image is extracted as the target region. It should be noted that the size (area) of the face region of the child in the image B3 is larger than that in the image B2.

Next, the tolerance setting unit 33A sets the tolerance for disclosure of the target region based on the feature of the target region extracted for each target image.

In the example shown in FIGS. 14, 0% is set as the tolerance for the character region in the image B1 based on the second information, that is, the right to disclose the target region. For the face region of the child in each of the images B2 to B4, for example, 70% for the image B2, 30% for the image B3, and 50% for the image B4 as the tolerance based on the first information, that is, the size of the face region of the child, the number of target regions in the target image, or the position of the target region in the target image.

It should be noted that the tolerance setting unit 33A may set the tolerance for each target region by, for example, a tolerance setting model (trained model) constructed by machine learning. The tolerance setting model is constructed by performing machine learning using learning data including a sample image of the target region and information (correct answer information) indicating a tolerance of the sample image.

In addition, the tolerance setting unit 33A may use a look-up table (hereinafter, also referred to as LUT) in which a correspondence relationship between the content of the target region and the tolerance is defined in advance, or may calculate the tolerance corresponding to the content of the target region in the target image from the LUT.

### User Setting Condition Reception Unit

The user setting condition reception unit 34A receives a condition set by the user, which is transmitted from the user terminal 100. For example, the user setting condition reception unit 34A receives a tolerance set for disclosure of a child of the user himself/herself as the condition set by the user in a case in which the user is a parent.

### Tolerance Information Transmission Unit

The tolerance information transmission unit 35A transmits information regarding the tolerance set for each target region by the tolerance setting unit 33A to the user terminal 100.

Examples of the “information regarding the tolerance” include an image of the target region and a tolerance (for example, 0% to 100%) set for the image of the target region.

### Tolerance Reception Unit

The tolerance reception unit 36A receives a change in the tolerance for the target region selected by the user after the tolerance is set by the tolerance setting unit 33A.

For example, the tolerance reception unit 36A receives a change to a side of increasing the tolerance from a setting point of the tolerance for the selected target region.

Specifically, in the example shown in FIGS. 14, 50% is set as the tolerance for the target region of the image B4, but the tolerance reception unit 36A may receive, for example, a change to a side of increasing the tolerance from 50%.

Specifically, in a case in which the tolerance for disclosure of the target region of the image B4 is set to be higher than the target regions of the other images B1, B2, B3, as shown in FIG. 15, the tolerance may be changed from 50% at the setting point of the tolerance to, for example, 80% such that the tolerance of the target region of the image B4 is higher than the tolerance of the target region of the other images.

### Display Layer Setting Unit

The display layer setting unit 37A sets the display layer of each image in a case of displaying the plurality of images such that a target region of a target image including a target region for which the first tolerance is set is hidden by a target image including a target region for which a second tolerance higher than the first tolerance is set.

Specifically, using the example shown in FIG. 14, the target image having a lower tolerance is set to a display layer that is lower. That is, among the four images B1 to B4, the image B1 including the target region having the lowest tolerance is set to the display layer that is the lowest layer, the image B3 including the target region having the second tolerance is set to the display layer that is higher than the display layer of the image B1, the image B4 including the target region having the third tolerance is set to the display layer that is higher than the display layer of the image B3, and the image B2 including the target region having the highest tolerance is set to the display layer that is higher than the display layer of the image B4.

In addition, the display layer setting unit 37A may reset the display layer such that the target region received by the target region reception unit 40A described below is hidden by another target image.

### Image Display Unit

The image display unit 38A displays each of the plurality of images including the two or more target images from which the target region is extracted on the set display layer.

For example, in the example shown in FIG. 14, the image display unit 38A may execute a performance (animated display) of displaying the target image having a higher tolerance in order, starting from the display screen on which only the image B1 having the lowest tolerance is displayed for the images B1 to B4.

### Emphasis Display Unit

In a case in which the target region is extracted from each of the two or more target images and there is a target image in which the target region is not hidden in the two or more target images, the emphasis display unit 39A emphasizes the target region that is not hidden.

Although not shown, the emphasis display unit 39A may emphasize the face region of the child in the image B2, which is the target region that is not hidden, on the display screen of the user terminal.

### Target Region Reception Unit

The target region reception unit 40A receives a selection of the user for any of target regions among the target region which is highlighted.

For example, in the example shown in FIG. 14, in a case in which the face region of the child of the image B2 is selected by the user, among the images B1 to B4, the image B2 selected by the user is set to the display layer that is the lowest layer, and the other images B1, B3, B4 are set to the display layers according to the tolerance.

That is, among the four images B1 to B4, the image B2 selected by the user is set to the display layer that is the lowest layer, among the three images B1, B3, B4 other than the image B2, the image B1 including the target region having the lowest tolerance is set to the display layer that is higher than the display layer of the image B2, the image B3 including the target region having the second tolerance is set to the display layer that is higher than the display layer of the image B1, and the image B4 including the target region having the third tolerance is set to the display layer that is higher than the display layer of the image B3.

In this case, the image B4 corresponds to the target image in which the target region is not hidden.

### Image Generation Unit

The image generation unit 41A generates a composite image consisting of the plurality of images.

### Image Display Flow According to Second Embodiment

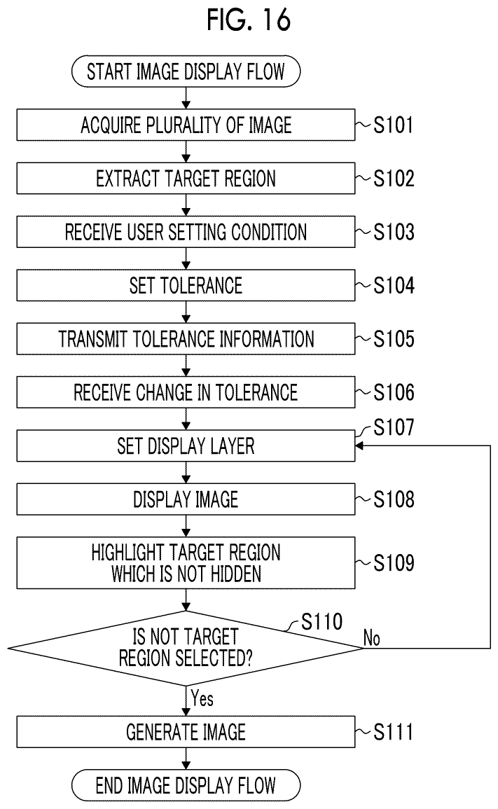

Next, an image display flow, which is a data processing flow using the image display apparatus 10A, will be described with reference to FIG. 16. It should be noted that the common parts with the image display flow according to the first embodiment will be omitted from the description.

In a case where a plurality of target images are transmitted from the user terminal 100, the processor 21A acquires the plurality of target images (S101). Next, the processor 21A applies a region-extraction model constructed by machine learning to a plurality of images to extract a target region from a target image including the target region among the plurality of images (S102).

Next, the processor 21A receives a condition set by the user for the tolerance, which is transmitted from the user terminal 100 (S103).

Thereafter, in a case in which the target region is extracted from each of the two or more target images, the processor 21A sets a tolerance for disclosure of the target region based on a feature of the target region extracted for each target image (S104).

More specifically, in step S104, the processor 21A acquires first information regarding at least one of a size of the target region, the number of target regions in the target image, or a position of the target region in the target image, as a feature of the target region, for each of the two or more target images. In addition, the processor 21A acquires second information regarding at least one of a right to disclose the target region or a scene indicated by the target region, as a feature of the target region, for each of the two or more target images.

Then, the processor 21A sets the tolerance for each target image based on a condition set by the user for the tolerance and at least one of the first information or the second information.

It should be noted that the processor 21A may set the tolerance for each target image based on at least one of the first information or the second information without performing step S103.

Next, the processor 21A transmits information regarding the tolerance set for each target region to the user terminal 100 (S105). Thereafter, the processor 21A receives a change in the tolerance for the target region selected by the user (S106).

It should be noted that the processor 21A may omit the execution of steps S105 and S106.

Next, the processor 21A sets the display layer of each image in a case of displaying the plurality of images such that a target region of a target image including a target region for which the first tolerance is set is hidden by a target image including a target region for which a second tolerance higher than the first tolerance is set (S107).

Thereafter, the processor 21A displays each of the plurality of images including the two or more target images from which the target region is extracted on the set display layer (S108). In this case, the processor 21A may execute a performance (animated display) of displaying the target images in order, and more specifically, may execute a performance of displaying the target image having a higher tolerance in order while hiding the target region of each target image, in response to the display of the target image having the lowest tolerance.

Next, in a case in which the target region is extracted from each of the two or more target images and there is a target image in which the target region is not hidden in the two or more target images, the processor 21A emphasizes the target region that is not hidden (S109).

Thereafter, the processor 21A receives a selection of the user for any target region of the emphasized target region, and in a case in which it is determined that there is no selection by the user (S110), the processor 21A generates a composite image consisting of the plurality of images (S111).

On the other hand, in a case in which it is determined that there is a selection by the user (S114), the processor 21A returns to step S107 and resets the display layer. The processor 21A repeats the execution of steps S107 to S110 until it is determined that there is no selection by the user.

The image display flow ends immediately at a time point at which the series of processing hitherto described ends.

### Effectiveness of Second Embodiment

As described above, the processor 21A sets the display layer of each image in a case of displaying the plurality of images such that a target region of a target image including a target region for which the first tolerance is set is hidden by a target image including a target region for which a second tolerance higher than the first tolerance is set, and displays each of the plurality of images including the two or more target images from which the target region is extracted on the set display layer.

According to the above configuration, the target region having a lower tolerance can be more appropriately hidden, so that it is possible to determine a more appropriate image arrangement in consideration of the intention of the user to disclose the image.

In addition, the processor 21 executes a performance of switching display or non-display of the target region for which the first tolerance is set.

According to the above configuration, it is possible to easily check the target region that is hidden by another image.

### Other Embodiments

In the image display apparatuses 10 and 10A described above, a region (image region and target region) to be hidden is specified, and each display layer for displaying the plurality of images such that the region is hidden is set.

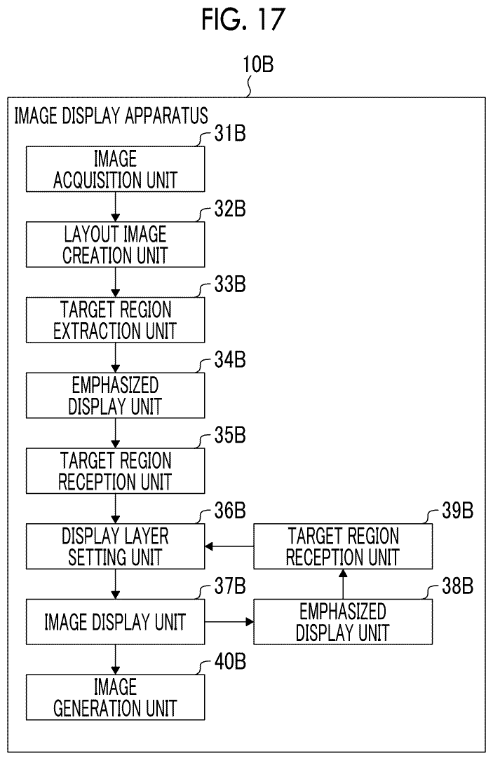

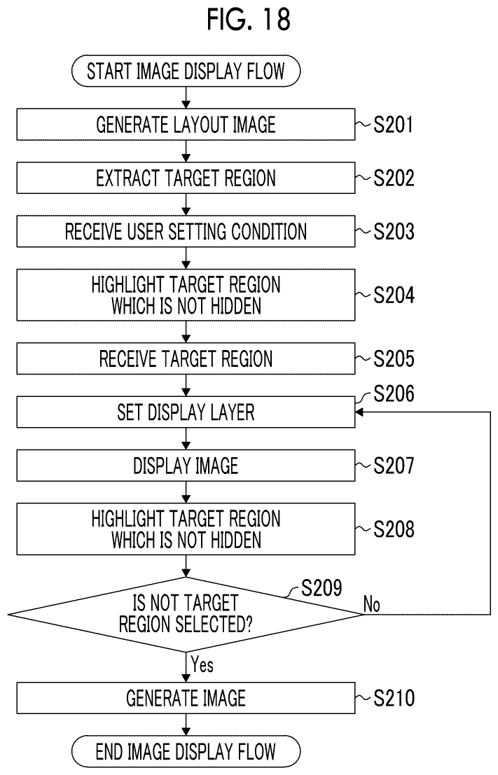

However, the present invention is not limited to this, and for example, as in an image display apparatus 10B shown in FIGS. 17 and 18, a temporary layout image of an image group consisting of a plurality of images may be created by temporarily arranging the image group in the layout region, a region to be hidden may be selected by the user from the layout image, and each display layer for displaying the plurality of images such that the region is hidden may be set.

More specifically, the image display apparatus 10B creates a layout image in which a plurality of images are randomly arranged in the layout region, extracts a target region that is not hidden from the layout image by using a region-extraction model (trained model), emphasizes the target region that is not hidden to the user, sets each display layer for displaying the plurality of images such that the target region selected by the user is hidden, and displays each of the plurality of images on the set display layer.

An image display system including the image display apparatus 10B has the same configuration as the image display system according to the first and second embodiments, and the image display apparatus 10B is configured by a server computer as in the image display apparatuses 10 and 10A, and includes a processor 21B, a memory, a communication interface, and a storage device.

As shown in FIG. 17, the image display apparatus 10B includes an image acquisition unit 31B, a layout image creation unit 32B, a target region extraction unit 33B, an emphasis display unit 34B, a target region reception unit 35B, a display layer setting unit 36B, an image display unit 37B, an emphasis display unit 38B, a target region reception unit 39B, and an image generation unit 40B.

These functional sections are implemented by the cooperation between the hardware device included in the computer constituting the image display apparatus 10B and the program (that is, software) installed in the computer.

Hereinafter, each of the functional units will be described.

The image acquisition unit 31B acquires a plurality of images transmitted from the user terminal 100.

The layout image creation unit 32B creates a layout image in which the acquired plurality of images are randomly arranged in the layout region. For the random arrangement of the image, a known technology related to the random arrangement of the image may be used.

The target region extraction unit 33B applies a region-extraction model constructed by machine learning to the layout image to extract a target region from the layout image. The region-extraction model is constructed by performing machine learning using learning data including a sample image of the layout image and information (correct answer information) indicating a target region included in the sample image.

It should be noted that the “target region” is the same as the target region according to the second embodiment described above, and examples of the target region include a face region of a person or a character region.

The emphasis display unit 34B and the target region reception unit 35B are the same as the emphasis display unit 39A and the target region reception unit 40A according to the second embodiment, so the description thereof will be omitted.

The display layer setting unit 36B sets the display layer of each image in a case of displaying the plurality of images such that the target region selected by the user is hidden by another image.

The image display unit 37B, the emphasis display unit 38B, and the target region reception unit 39B are the same as the image display unit 38A, the emphasis display unit 39A, and the target region reception unit 40A according to the second embodiment, so the description thereof will be omitted.

It should be noted that the image display apparatus 10B may have the functions of the subject identifying unit 32, the selected subject determination unit 33, and the image region determination unit 36 according to the first embodiment, instead of the target region extraction unit 33B.

Next, an image display flow, which is a data processing flow using the image display apparatus 10B described above, will be described with reference to FIG. 18. It should be noted that the common parts with the image display flow according to the first and second embodiments will be omitted from the description.

In a case where a plurality of target images are transmitted from the user terminal 100, the processor 21B acquires the plurality of target images (S201). Next, the processor 21B creates a layout image in which the acquired plurality of images are randomly arranged in the layout region (S202). Thereafter, the processor 21B applies a region-extraction model constructed by machine learning to the layout image to extract a target region from the layout image (S203).

Next, the processor 21B emphasizes the target region that is not hidden in the layout image (S204). Thereafter, the processor 21B receives a selection of the user for any target region of the emphasized target region (S205).

Next, the processor 21B sets the display layer of each image in a case of displaying the plurality of images such that the target region selected by the user is hidden by another image (S206).

Thereafter, the processor 21B displays each of the plurality of images including the target image on the set display layer (S207).

Next, in a case in which there is a target image in which the target region is not hidden, the processor 21B emphasizes the target region that is not hidden (S208).

Thereafter, the processor 21B receives a selection of the user for any target region of the emphasized target region, and in a case in which it is determined that there is no selection by the user (S209), the processor 21B generates a composite image consisting of the plurality of images (S210).

On the other hand, in a case in which it is determined that there is a selection by the user (S209), the processor 21B returns to step S206 and re-sets the display layer. The processor 21B repeats the execution of steps S206 to S209 until it is determined that there is no selection by the user.

The image display flow ends immediately at a time point at which the series of processing hitherto described ends.

As described above, in the image display apparatus 10B, a temporary layout image of an image group consisting of a plurality of images is created by temporarily arranging the image group in the layout region, and a region to be hidden is selected by the user from the layout image.

As a result, it is possible to determine an appropriate image arrangement in consideration of the intention of the user to disclose the image.

In addition, in the image display system, the image display apparatuses 10, 10A, and 10B are configured by the server computer, but the present invention is not limited to this, and for example, the image display apparatus according to the aspect of the present invention may be configured by the user terminal.

The image display apparatus according to the aspect of the present invention and the processor provided in the image display apparatus include various processors. The various processors include, for example, a CPU, which is a general-purpose processor that executes software (programs) to function as various processing units.

In addition, the various processors include a programmable logic device (PLD) that is a processor of which a circuit configuration is changeable after manufacture, such as a field-programmable gate array (FPGA).

Further, the various processors also include a dedicated electric circuit that is a processor of which a circuit configuration is specially designed to execute specific processing, such as an application-specific integrated circuit (ASIC).

Further, the image display apparatus according to the embodiment of the present invention, or one processing unit included in the image display apparatus, may be configured by any one of the above-described processors, or by a combination of two or more homogeneous or heterogeneous processors, for example, a combination of multiple FPGAs or a combination of an FPGA and a CPU.

Moreover, a plurality of functional sections provided in the image display apparatus according to the embodiment of the present invention may be configured by using one of various processors, or may be configured by using one processor in which two or more of the plurality of functional sections are combined.

Further, as in the above-described embodiments, one processor may be configured as a combination of one or more CPUs and software, and this processor may operate as the plurality of functional units.

Furthermore, for example, as typified by a system on chip (SoC), it is also possible to adopt a configuration that uses a processor which implements, on a single integrated circuit (IC) chip, the functions of an entire system including the plurality of functional units in the image display apparatus according to the embodiment of the present invention and the image display apparatus. Furthermore, the hardware configuration of the various processors described above may be an electrical circuit (circuitry) formed by combining circuit elements such as semiconductor devices.

### EXPLANATION OF REFERENCES

10, 10A, 10B: image display apparatus
21, 21A, 21B: processor
22: memory
23: communication interface
24: storage device
31, 31A, 31B: image acquisition unit
32: subject identifying unit
32A, 33B: target region extraction unit
32B: layout image creation unit
33: selected subject determination unit
33A: tolerance setting unit
34: subject information transmission unit
34A: user setting condition reception unit
34B: emphasis display unit
35: selected subject reception unit
35A: tolerance information transmission unit
35B: target region reception unit
36: image region determination unit
36A: tolerance reception unit
36B, 37A, 39: display layer setting unit
37: first image determination unit
37B, 38A, 40: image display unit
38: second image determination unit
38B, 39A, 41: emphasis display unit
39B, 40A: target region reception unit
40B, 41A, 43: image generation unit
42: image region reception unit
100: user terminal
E: image region
N: network
S: image display system

What is claimed is:

1. An image display apparatus comprising:
a processor,
wherein the processor is configured to:
identify, for each of a plurality of images, a subject within the image;
determine a selected subject from among the subjects identified for the plurality of respective images;
set, for display of the plurality of images, a display layer for each image such that an image region of the selected subject in a first image including the selected subject is hidden by a second image different from the first image; and
display each of the plurality of images, including the first image and the second image, on the set display layer.

2. The image display apparatus according to claim 1,
wherein the processor is configured to:
identify a plurality of types of subjects included in the plurality of images; and
determine the selected subject from among the plurality of types of subjects.

3. The image display apparatus according to claim 1,
wherein the second image is an image among the plurality of images that does not include the selected subject.

4. The image display apparatus according to claim 1,
wherein the processor is configured to select the selected subject from among the identified subjects for each of the plurality of images based on a predetermined selection criterion.

5. The image display apparatus according to claim 1,
wherein the processor is configured to receive, as the selected subject, a subject selected by a user from among the identified subjects for each of the plurality of images.

6. The image display apparatus according to claim 1,
wherein the processor is configured to determine, in a case where the image region of the selected subject is present in each of two or more first images and a first image in which the image region of the selected subject is not hidden is present, the first image in which the image region of the selected subject is to be hidden from among the two or more first images based on information regarding the image region of the selected subject in each of the two or more first images.

7. The image display apparatus according to claim 1,
wherein the processor is configured to:
highlight, in a case where the image region of the selected subject is present in each of two or more first images and a first image in which the image region of the selected subject is not hidden is present in the two or more first images, the image region of the selected subject that is not hidden;
receive a user selection of any of the image regions which are highlighted of the selected subject; and
reset the display layer such that the image region of the selected subject selected by a user is hidden.

8. The image display apparatus according to claim 1,
wherein the processor is configured to execute a performance of switching display or non-display of the image region of the selected subject.

9. An image display apparatus comprising:
a processor,
wherein the processor is configured to:
apply a region-extraction model constructed by machine learning to a plurality of images and extract a target region from a target image that includes the target region from among the plurality of images;
set, in a case where the target region is extracted from each of two or more target images, a tolerance for disclosure of the target region based on a characteristic of the target region extracted for each of the target images;
set, for display of the plurality of images, a display layer for each image such that the target region of the target image including the target region in which a first tolerance is set is hidden by the target image including the target region in which a second tolerance higher than the first tolerance is set; and
display each of the plurality of images including the two or more target images from which the target region has been extracted on the set display layer.

10. The image display apparatus according to claim 9,
wherein the processor is configured to:
acquire, for each of the two or more of the target images, as the characteristic of the target region, first information regarding at least one of a size of the target region, the number of the target regions in the target image, or a position of the target regions in the target image; and
set the tolerance based on the first information.

11. The image display apparatus according to claim 9,
wherein the processor is configured to:
acquire, for each of the two or more target images, as the characteristic of the target region, second information regarding at least one of a right to disclose the target region or a scene represented by the target region; and
set the tolerance based on the second information.

12. The image display apparatus according to claim 9,
wherein the processor is configured to set the tolerance based on a condition set by a user regarding the tolerance and the characteristic of the target region extracted for each target image.

13. The image display apparatus according to claim 9,
wherein the processor is configured to accept a change to the tolerance for the target region which is selected, after setting the tolerance.

14. The image display apparatus according to claim 13,
wherein the processor is configured to accept, for the target region which is selected, a change to increase the tolerance to a level higher than that at a time when the tolerance is set.

15. The image display apparatus according to claim 9,
wherein the processor is configured to:
highlight, in a case where the target region is extracted from each of the two or more target images and the target image in which the target region is not hidden is present among the two or more target images, the target region which is not hidden;
receive a user selection of any of the target regions which are highlighted; and
reset the display layer such that the target region which is selected by a user is hidden by the target image that does not include the target region which is selected by the user.

16. The image display apparatus according to claim 9,
wherein the processor is configured to execute a performance of switching display or non-display of the target region in which the first tolerance is set.

17. An image display method executed by a processor, the method comprising:
identifying, for each of a plurality of images, a subject within the image;
determining a selected subject from among the subjects identified for the plurality of respective images;
setting, for display of the plurality of images, a display layer for each image such that an image region of the selected subject in a first image including the selected subject is hidden by a second image different from the first image; and
displaying each of the plurality of images, including the first image and the second image, on the set display layer.

18. An image display method executed by a processor, the method comprising:
applying a region-extraction model constructed by machine learning to a plurality of images and extracting a target region from a target image that includes the target region from among the plurality of images;
setting, in a case where the target region is extracted from each of two or more target images, a tolerance for disclosure of the target region based on a characteristic of the target region extracted for each of the target images;
setting, for display of the plurality of images, a display layer for each image such that the target region of the target image including the target region in which a first tolerance is set is hidden by the target image including the target region in which a second tolerance higher than the first tolerance is set; and
displaying each of the plurality of images including the two or more target images from which the target region has been extracted on the set display layer.

19. A non-transitory computer-readable storage medium on which a program for causing a computer to execute each process included in the image display method according to claim 17 is stored.

20. A non-transitory computer-readable storage medium on which a program for causing a computer to execute each process included in the image display method according to claim 18 is stored.
